(19) United States
(12) Patent Application Publication
(10) Pub. No.: US 2019/0141794 A1
(43) Pub. Date: May 9, 2019

(54) TEMPERATURE SENSING COOKWARE

(71) Applicant: Lily Rose Richcreek, Santa Ana, CA (US)

(72) Inventor: Lily Rose Richcreek, Santa Ana, CA (US)

(21) Appl. No.: 16/177,741

(22) Filed: Nov. 1, 2018

Related U.S. Application Data
(60) Provisional application No. 62/582,149, filed on Nov. 6, 2017.

(51) Int. Cl. H05B 6/06; F24C 7/08; A47J 45/06; A47J 27/00

(52) U.S. Cl. CPC H05B 6/062; F24C 7/083; A47J 27/62; A47J 27/002; H05B 2213/07; A47J 45/068

(57) ABSTRACT

A cookware system that measures temperature is disclosed. In certain embodiments disclosed herein, the system includes a cooking base and a handle. The cooking base is connected to a temperature sensor. The handle includes a display that indicates a temperature level as measured by the temperature sensor. In certain embodiments, a desired temperature level can be set through a user interface in the handle which can allow a user to be notified when the cooking base reaches the desired temperature level. Advantageously, by notifying the user when the cooking base reaches the temperature level, the user can either adjust a cooktop power level to adjust the heat or start cooking using the cookware system.

### RELATED APPLICATION

This disclosure claims priority to U.S. Provisional Application No. 62/582,149, which was filed on Nov. 6, 2017 and is titled “TEMPERATURE SENSING COOKWARE,” the disclosure of which is expressly incorporated by reference herein in its entirety for all purposes. Any and all applications, if any, for which a foreign or domestic priority claim is identified in the Application Data Sheet of the present application are hereby incorporated by reference in their entireties under 37 CFR 1.57.

### BACKGROUND

While most cooktops have settings that manage power levels, such as a low, medium, and high setting, these settings are not consistent across different cooktops, leaving an inexperienced cook to guess what setting would work best for the particular food item when cooking with an unfamiliar cooktop. This guessing process can result in burnt or undercooked food because cooks may choose the wrong power level for the food they are preparing.

Novice cooks, therefore, have a need for a mechanism that allows them to adjust the power level of the cooktop in response to the temperature of the food being cooked. Thus, what is needed is a product that can accurately measure the temperature of the pan so that the power level of the cooktop can be adjusted to maintain the desired food temperature.

### SUMMARY

The systems, methods, and devices of this disclosure each have several innovative aspects, no single one of which is solely responsible for all of the desirable attributes disclosed herein. Details of one or more implementations of the subject matter described in this specification are set forth in the accompanying drawings and the description below.

In certain embodiments, a cooking system is disclosed. The cooking system may include any type of pan, grill, skillet, fry, or saucepan with a cooking base and handle. A temperature sensor may be integrated within, or included as part of the cooking base. In certain embodiments, the handle may be detachable. The handle may include an electrical connection to the temperature sensor embedded in the cooking base. The detachable handle may include a display. The display may indicate the temperature measurement from the embedded temperature sensor.

In certain embodiments, the handle may also contain a user interface to enable a user to set one or more indicators for one or more desired temperatures. The indicators for desired temperatures may correspond to cooking temperatures for certain foods, such as eggs, chicken, fish, beef, or vegetables.

In certain embodiments, the cooking base and handle may be water resistant such that they can be washed.

In certain embodiments, the detachable handle may also contain a wireless connectivity device. This wireless connectivity device may allow the digital cookware to communicate with an external processor to transmit temperature data. In some embodiments, the external processor may communicate to the user that the cookware has reached a certain temperature. In some embodiments, the wireless connectivity device or the external processor may also communicate with the cooktop to adjust power levels in order to maintain a desired temperature.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIGS. 1A-B are, respectively, front and side views of an example of digital cookware in accordance with certain embodiments disclosed herein.

FIG. 2 is a flow chart of an example process for monitoring the temperature of the cookware system and enabling adjustment of a cooktop power level.

FIG. 3 is a flow chart of an example process for interacting with the system, setting the temperature, being notified of the temperature, and enabling adjustment of the temperature if it exceeds a threshold range for the desired temperature and for safety.

### DETAILED DESCRIPTION

### Introduction

As previously described, novice cooks have a need for a mechanism to allow for adjustment or readjustment of temperature on an unfamiliar cooktop. Since cooktops are inconsistent in their power output, and it can be difficult for some cooks to know what setting on the cooktop will correspond to the resulting temperature of the cookware on the cooktop. While some cooks may use a separate thermometer to check the food temperature, a separate thermometer cannot measure the overall temperature of the whole pan of food at once and can therefore lead to a misleading measurement due to temperature inconsistencies across the pan.

Embodiments disclosed herein attempt to address the above problem by including a cookware system that can accurately sense the temperature of the cookware so that the power level of the stove can be adjusted to the level corresponding to the cook's desired temperature. In certain embodiments disclosed herein, the system includes a combination of a cooking base that contains a temperature sensor and a detachable handle that contains a display and/or a mechanism to set a desired cooking temperature. The temperature sensor can be a distributed sensor or set of sensors that are distributed throughout the surface area or a portion of the surface area of the cookware (e.g., a frying pan or saucepan). By distributing the sensor throughout a portion of the surface area (e.g., the base) of the cookware, it is possible to obtain a more accurate temperature for the cookware. In some embodiments, an average temperature of the cookware representing the average temperature of the measured surface of the cookware is presented. In certain embodiments, multiple temperatures are presented representing the temperature of different portions of the cookware. Advantageously, in certain embodiments, by presenting temperatures associated with different portions of the cookware, a user can determine whether the cookware is not centered on the heating element, or if the heating element is unbalanced or is not heating evenly, as may occur if there is a clog in a portion of gas stove top or if an electrical heating element is damaged. Advantageously, by sensing the temperature of the cookware, the power level of the cooktop can be adjusted. The adjustment can be made automatically or by the user.

### Example Cookware System

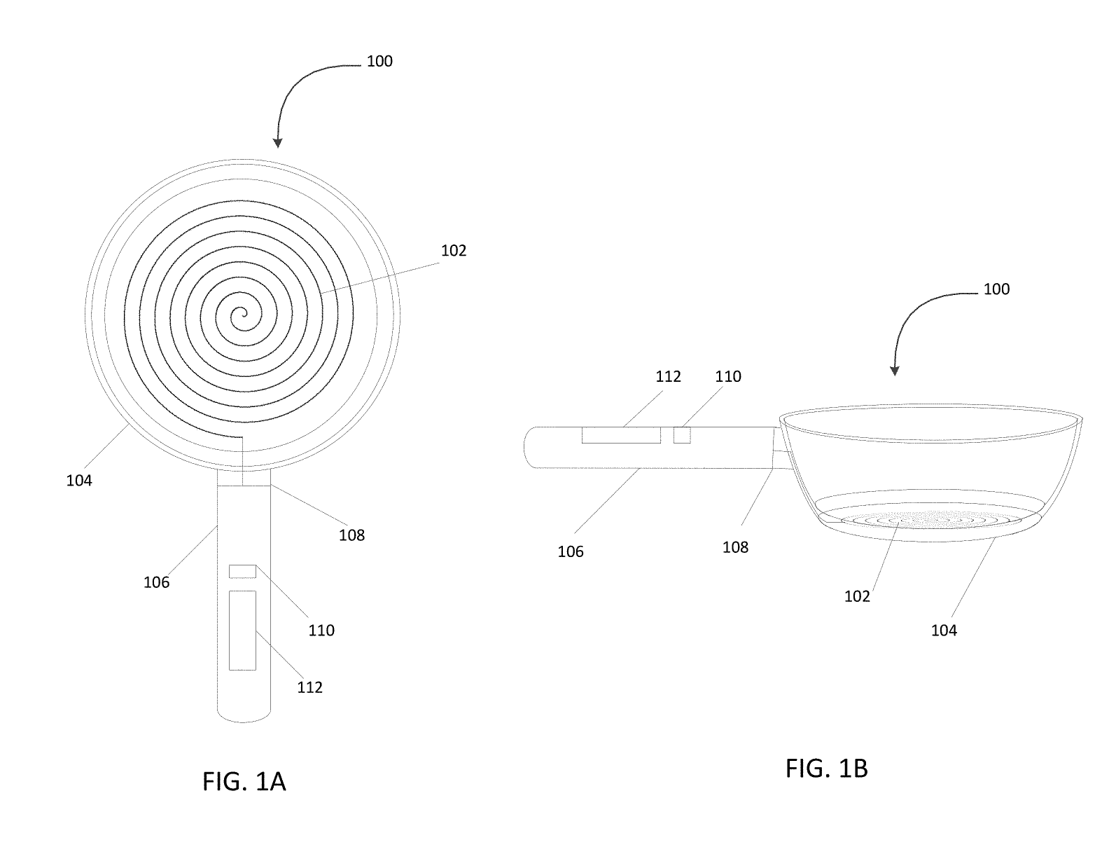

FIGS. 1A and 1B illustrate an example of a cookware system 100 in accordance with certain embodiments disclosed herein. The cookware system 100 includes a temperature sensor 102 which is coupled to or connected to a cooking base 104. The cooking base 104 may be coated with a food safe material on its top portion. The cooking base 104 may be coupled to or connected to a handle 106. In certain embodiments, the handle 106 may be detachable. The handle 106, includes a display 112 and a user interface that includes one or more interface elements that enable a user to specify a desired temperature for one or more foods to be cooked within the cookware system 100. The user interface may include one or more physical buttons or may be implemented as part of a touchscreen interface. The display 112 may include a digital display and heat resistant glass. The display 112 may display or output the temperature of the cooking base 104 as measured by the temperature sensor 102.

The user interface may include programmed temperature levels that correspond to particular temperatures for cooking different types of foods like eggs, chicken, fish, beef, or vegetables. The programmed temperature levels may be programmed by a manufacturer, or other user. Having programmed temperature levels can be advantageous because a novice cook could select the setting for the type of food they would like to cook without having to know what temperature to set for that food. The user interface may include a number of user determined settings of desired temperature levels for cooking temperatures for foods that are personal or frequent favorites of the user. Programming desired food temperatures may enable the user to personalize the cookware system to remember the correct settings for the user's favorite foods. Further, programming temperature settings for particular foods into the cookware system 100 can reduce food preparation time by eliminating the need for the user to lookup the appropriate cooking temperature during subsequent cooking sessions. The user interface may also include a mechanism to adjust a desired temperature level in increments. For example, the mechanism may include physical buttons or a touchscreen interface with a positive five degree temperature increment setting and a negative five degree temperature increment setting that could respectively add or subtract five degrees to the previously programmed temperature setting upon selection. In certain embodiments, when the cooking base 104 reaches the desired temperature, as measured by temperature sensor 102, the cookware system will notify the user. The user may be notified by an audible alert and/or a visual message on the display 112. Providing an alert can be advantageous because the notification may alert a user that it is time to start cooking and will prevent a user from starting to cook food too soon, such as before the pan is at the desired temperature.

In certain embodiments, the user interface may be used to set a desired range of acceptable temperatures for the cooking base 104, such that when the cooking base 104 falls below the desired range or rises above the desired range, the cookware system will notify the user. In certain embodiments, alerting the user of temperature changes is advantageous because it enables a user to adjust for unexpected temperature changes. Temperature changes may occur because temperature throughout cooking is typically not static. Temperature may fluctuate with an adjustment in heat settings, ambient temperature, or when adding ingredients to the cooking base. It can be beneficial for a cook to know when the temperature of the pan falls below a desired cooking temperature for a particular food item as well as when the pan gets too hot after some time sitting on the cooktop. In this way, the cook can ensure that the food is cooked at the desired temperature for the type of food item, dish, or recipe.

In certain embodiments, the user interface may be controlled wirelessly by a user through a control device, which may include one or more hardware processors and is in communication with the cookware system 100 directly or through a network. In some embodiments, the control device may be an application specific device. In other embodiments, the control device may be a general-purpose device that includes programming for interacting with the cookware system 100. For example, a user may interact with the cookware system 100 using a user computing device or a mobile device, such as a smartphone, tablet, laptop, or remote control. The control device may be programmed to allow a user to set a desired temperature level of the cooking base 104 such that the cookware system will transmit a notification to the control device when the cooking base 104 reaches the desired temperature level. The user may then be notified by the external processor that the cooking base 104 has reached the desired temperature level or fallen within or outside of a desired temperature range.

In certain embodiments, the cookware system 100 may periodically transmit temperature information, as measured by the temperature sensor 102, to an external processor. The mobile device may be monitored by a user to determine temperature of the cooking base 104. The user may then adjust the power level of the cooktop to increase or decrease the temperature of the cooking base 104 based on the temperature of the cooking base 104. Alternatively, a control device or other computing device may communicate with the cooktop directly to adjust the power level of the cooktop in order to increase or decrease the temperature of the cooking base 104.

The temperature sensor 102 may be embedded into the cooking base 104. The temperature sensor 102 may be in a spiral shape, so as to maximize the area by which the temperature sensor 102 can detect heat. In some embodiments, maximizing the area of temperature measurement is important because certain cooktops may heat the cooking base 104 unevenly. If the temperature sensor 102 were localized to a particular area of the cooking base 104, the temperature sensor 102 may get an inaccurate reading of the overall temperature of the cooking base 104. Thus, in order to get an average of the cooking temperature of the cooking base 104, the temperature sensor 102 should be in a shape that maximizes the area in which it can detect temperature.

The cookware system 100 may be designed to resist water damage when washing. The handle 106 may be detachable and can be washed separately from the cooking base 104. The handle 106 may be attachable to different types of cooking bases, such as a pan, grill, skillet, fry, or saucepan. The handle 106 may be coupled to or connected to the cooking base 104 at a connection point 108. The connection point 108 may include an electrical connection from the handle 106 to the temperature sensor 102. The electrical connection may be enclosed in the connection point 108.

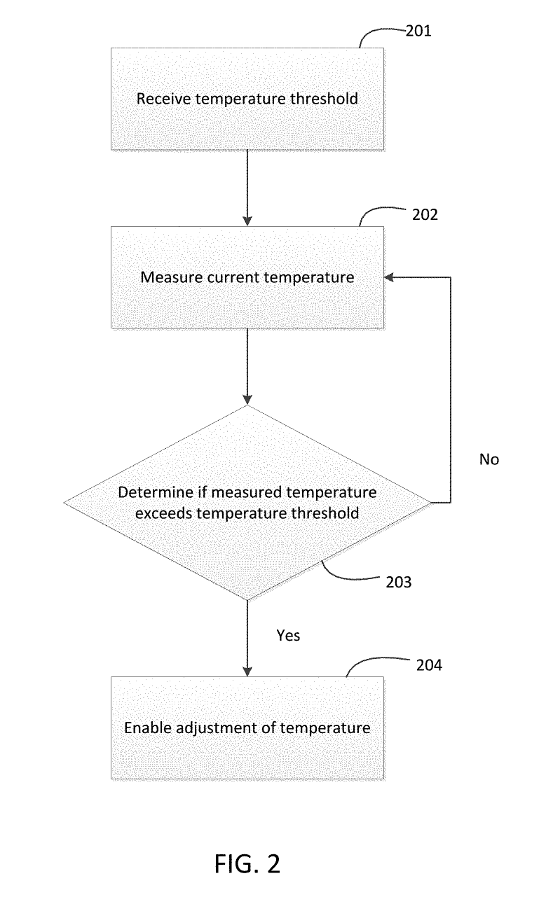

FIG. 2 is a flow chart of an example process for monitoring the temperature of the cookware system and enabling adjustment of a cooktop power level. The process may be performed by a cookware system 100. In some embodiments, the process may be performed in conjunction with a wireless device and/or a cooking unit, such as a stove, oven, microwave, or other device capable of cooking food.

The process may begin at block 201 with the cookware system 100 receiving a temperature threshold. This temperature threshold may represent a temperature that a user desires the cookware system 100 to maintain. In some embodiments, the user may identify a food, and the cookware system 100 may determine the temperature threshold based on the identity of the food. In some cases, receiving the identity of the food may also include receiving a quantity of the food and/or a desired cooking for the food (e.g., crunchy, soft, medium, medium-well, well-done, etc.). Based on the information received, the cookware system 100 can determine a desired temperature threshold. In some embodiments, the temperature threshold is a temperature range to maintain the cookware system 100, or the cookware base 104. The cookware system 100 may determine the desired temperature for the food based on data stored in a memory of the cookware system 100. Alternatively, or in addition, the cookware system 100 may access a knowledge base via a network, such as the Internet, to determine the appropriate cooking temperature for the food to be cooked or the quantity or type of cooking for the food.

At block 202, the cookware system 100 using, for example, the temperature sensor 102, measures a current temperature of the cookware base 104 or cookware system 100. Measuring the temperature may include measuring an average temperature of the entire base 104 or temperatures of different portions of the cookware base 104. In some embodiments, the temperature sensor may measure temperatures of portions of the cookware system 100 other than the base (e.g., the sidewalls of the cooking pot). In certain embodiments, the cookware system 100 may calculate a temperature of a space or area within the cooking pot, which may or may not be on the surface of the cooking pot, based on a plurality of measurements obtained from different portions of the cooking surface of the cookware system 100. For example, by measuring a temperature of different edges and the center of the cookware system 100, it can be determined a temperature or likely temperature for an area within a particular distance of the cookware system 100 or the cookware base 104.

At decision block 203, the cookware system 100 determines if the measured temperature exceeds the temperature threshold. If the measured temperature does not exceed the temperature threshold, the process may return to block 202 where the cookware system 100 may continue to measure the temperature on either a continuous basis, or periodically.

If it is determined that the measured temperature exceeds the temperature threshold, the cookware system 100 may adjust a temperature of the cooking system at block 204. The cookware system 100 may communicate wirelessly with the cooking system to adjust its temperature. For example, the cookware system 100 may communicate using BLUETOOTH to cause the cookware system to adjust its temperature by, for example, reducing the gas or heat settings of the cookware system. In some embodiments, the temperature may be increased or decreased based on whether the measured temperature is above an upper threshold or below a lower temperature threshold.

In certain embodiments, the process 300 is performed after a user has indicated that cooking is to commence. Thus, the cookware system 100 may be prevented from adjusting a temperature of an oven when the user is not intending to cook or is not yet ready for the oven or other cooking system to be activated.

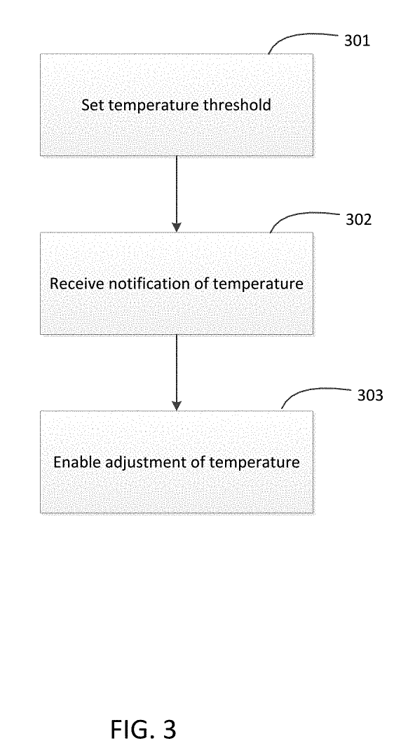

FIG. 3 is a flow chart of an example process of alerting a user of a temperature for a cooking system 100. The process may be performed by a cookware system 100. In some embodiments, the process may be performed in conjunction with a wireless device and/or a cooking unit, such as a stove, oven, microwave, or other device capable of cooking food.

The process may begin at block 301 with the cookware system 100 receiving a temperature threshold. The temperature threshold may be set by a user or otherwise determined based on food to be cooked. In certain embodiments, the block 301 may include one or more of the embodiments described with respect to the block 201.

At block 302, a monitoring device, such as a smartphone or other wireless device, may receive a notification of a temperature of the cookware system 100. Alternatively, or in addition, the cooking system, such as an oven, stove top, or microware, may receive a notification of the temperature.

At block 303, the cooking system can automatically adjust the temperature based on the notified temperature. Alternatively, or in addition, a user can adjust the temperature of the cooking system. The user may enter a change to the temperature or to the cooking settings into the monitoring device. The desired temperature change or change in cooking settings can be transmitted directly to the cooking system to adjust the temperature settings of the cooking system. Alternatively, or in addition, the settings may be transmitted to the cookware system 100, which can adjust the cooking system settings.

### ADDITIONAL EMBODIMENTS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. For example, in some embodiments, the adjustment of the desired temperature may be performed by a hardware processor that implements control software and that is in communication with the handle. Further, desired temperature settings may be input by a user via a user interface that controls the processor or provides configuration settings for the processor. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A cookware system configured to measure temperature so that a power level of a cooktop can be adjusted, the cookware system comprising:
a cooking base, configured to conduct heat;
at least one temperature sensor connected to the cooking base and configured to measure a temperature of the cooking base;
a handle coupled to the cooking base; and
a wireless connectivity device, wherein the wireless connectivity device:
receives the output from the temperature sensor; and
transmits the output to an external processor.

2. The cookware system of claim 1, wherein the at least one temperature sensor is configured in a spiral shape.

3. The cookware system of claim 1, wherein the handle further comprises a display, a user interface, and an alert system wherein:
the display is configured to indicate the output;
the user interface is configured to specify an alert threshold corresponding to a particular temperature; and
the alert system is configured to alert a user when the temperature of the cooking base satisfies the alert threshold.

4. The cookware system of claim 1, wherein the handle is detachable.

5. The cookware system of claim 1, wherein the cookware system is further configured to resist water damage.

6. The cookware system of claim 1, wherein the external processor is a mobile device.

7. The cookware system of claim 1, wherein the external processor is connected to the cooktop and is further configured to adjust the power level of the cooktop in response to the output.

8. A method to monitor and adjust temperature of cookware, the method comprising:
receiving a temperature threshold;
measuring current temperature of a cookware base being on a cooktop, wherein the cooktop produces power to heat the cookware base;
determining if the current temperature exceeds the temperature threshold;
enabling adjustment of the cooktop power in response to whether the current temperature satisfies the temperature threshold;

9. The method of claim 8, wherein enabling adjustment of the cooktop power comprises notifying a user that the current temperature satisfies the temperature threshold.

10. The method of claim 8, wherein enabling adjustment of the cooktop power comprises notifying an external processor connected to the cooktop to adjust the cooktop power.
